(19) United States
(12) Patent Application Publication
(10) Pub. No.: US 2023/0119102 A1
(43) Pub. Date: Apr. 20, 2023

(54) ARTIFICIAL INTELLIGENCE ASSISTED REAL TIME QUOTATIONS

(71) Applicant: Donald R. Hobdy, Long Beach, CA (US)

(72) Inventor: Donald R. Hobdy, Long Beach, CA (US)

(21) Appl. No.: 18/047,531

(22) Filed: Oct. 18, 2022

Related U.S. Application Data
(60) Provisional application No. 63/256,740, filed on Oct. 18, 2021.

(51) Int. Cl. G06Q 40/08; G06N 3/08; G06Q 30/0601

(52) U.S. Cl. CPC G06Q 40/08; G06N 3/08; G06Q 30/0611

(57) ABSTRACT

Systems and methods are described to utilize artificial intelligence to customize insurance rate quotes to customers. A computing device with an artificial intelligence logic is utilized. The computing device can be configured for receiving a request to generate a quote from a user such as a customer. In response, the systems and methods can access historical data about the customer from a plurality of sources. Data may also be further configured for retrieving third-party data about the customer and then analyzing the historical and third-party data in real time to determine and generate the quote, which may then be returned to the customer. Often, the third-party data may include telematic data and psychographic data personalized to the customer, among other data.

### PRIORITY CLAIM

This application claims the benefit of and priority to U.S. Provisional Patent Application No. 63/256,740, filed on Oct. 18, 2021, which is incorporated in its entirety herein.

### FIELD

The present disclosure relates to artificial intelligence. More particularly, the present disclosure relates to real time generation of quotations using artificial intelligence.

### BACKGROUND

In recent years, the field of data science and the use of so-called “big data” has become more and more prevalent as companies attempt to make sense and profit out of the petabytes of internal and external data available to them. As customers and others use the Internet for commerce, education, entertainment, etc., they leave behind a substantial amount of personal data (sometimes known as their “online footprint”). Meanwhile, government records are increasingly available online, providing even more data about individuals. While raising legitimate privacy concerns, the presence of all this personal data makes it possible for third parties to create and sell detailed profiles of individuals.

During this time, the use of Artificial Intelligence (AI) has become more and more ubiquitous as it enables new applications that were previously impossible by either manual calculations or other sorts of computing. One important power of AI is that it can find and recognize patterns in large quantities of data that are beyond the cognitive ability of human beings to detect. This creates opportunities for applications and innovations that were previously unattainable.

This is particularly true in legacy and/or actuarial applications like, for example, the setting of insurance rates. Insurers can use AI to assess rick and determine rates by customizing them to each individual customer more precisely. The traditional group-based historical data may still be employed, sometimes as a baseline, but third personal data and/or profiles may then be used to assess an individual's specific risk factors and adjust the rates appropriately. This increases profits to the insurance company by better controlling individual risks while offering more competitive rates to customers.

### BRIEF DESCRIPTION OF DRAWINGS

The above and other aspects, features, and advantages of several embodiments of the present disclosure will be more apparent from the following description is presented in conjunction with the following several figures of the drawings.

FIG. 1 is a schematic block diagram of a computer network in accordance with an embodiment of the disclosure;

FIG. 2A is a schematic block diagram of a system comprising a host-computing device in accordance with an embodiment of the disclosure;

FIG. 2B is a schematic block diagram of an artificial intelligence logic in accordance with an embodiment of the disclosure;

FIG. 2C is a conceptual illustration of an artificial neural network in accordance with an embodiment of the disclosure;

FIG. 3A is a flowchart depicting a process for risk determination in accordance with an embodiment of the disclosure;

FIG. 3B is a flowchart depicting a subprocess for data acquisition in accordance with an embodiment of the disclosure; and

FIG. 3C is a flowchart depicting a subprocess for data analysis in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common but well-understood elements that are useful or necessary in a commercially feasible embodiment are often not depicted in order to facilitate a less obstructed view of these various embodiments of the present disclosure.

### DETAILED DESCRIPTION

In response to the situations described above, apparatus and methods are described to utilize AI to customize auto insurance rates, though the inventive principles describe herein may have broader application. A customer may engage with an insurer to meet an auto insurance need. It could be a direct customer for personal need but may also be a rental agency, other operator of a fleet of vehicles, or embedded in the purchasing process of a vehicle. The customer may make a Request For Quote (RFQ) through an agent, online, or via another means, like, for example, a kiosk an airport. The insurer may process the RFQ through its intake software. In the case of an existing customer, all of the customer's data with the customer may be retrieved and updated if necessary. The insurer may access the historical data it uses in its legacy risk analysis, perform a risk analysis, and then tentatively classify the customer into a rick group or subgroup.

The insurer may access historical data from third parties. This data may be from government records like a driver's personal and/or vehicle records from a state government Department of Transportation, Department of Motor Vehicles (DMV), or equivalent agency. It may be other government data like, for example, criminal records, property tax payments, etc., that might shed some light on a driver's skills and overall reliability.

The insurer may also access telematic data from the driver's vehicle or third parties. Given the highly computerized nature of modern automobiles, there is typically a diagnostic port available which may export data about how a driver handles the vehicle. Data with regards to braking, cornering, activation of driver assist functions, etc., may be available from coupling a device to the vehicle's diagnostic port, from the automotive manufacturer, a third party application connected through the vehicle or cellular device, through wi-fi, or some third party with access to the data. This data may be received or recorded in real time by means of, for example, a cellular connection and/or transceiver coupled to the vehicle.

Similarly, tracking data about driving habits may also be available, like, for example, destinations, routes taken, distances traveled, time of day, stops, etc. In some cases, data relating to electric vehicles, partially or completely self-driving vehicles, and or entire fleets of vehicles may be available.

The insurer may access psychographic data from third parties. This may include credit data as well as lifestyle information derived from social media, lifestyle, use of mobile applications, subscriptions (websites, magazines, cable channels, etc.), and retail transactions (time, date, place, and transaction details).

The historic, telematic, and psychographic data may then be normalized and sent an AI model that is able to look for patterns and trends that would be indecipherable by a human analyst. Some patterns might make perfect sense to a human. For example, if a driver stops at a fast-food restaurant every day on the way to work, it might place him or her into a higher risk because eating on the way to work makes someone less attentive to driving. It may not matter if a particular driver actually eats the food while driving or waits until he or she gets to work. The pattern the AI picked up on is the correlation between such stops (trackable) and not the time of eating itself (not trackable). All drivers with this particular habit will have a slightly higher risk assigned to them.

In other cases, the correlations made by the AI may make no sense at all to a human. Hypothetically, data may show that people who stop to drop off and pick up laundry several days a week during their commute have fewer accidents. It is hard to understand why that would be, but whatever the cause the AI may catch it and lower a driver's risk accordingly. Dozens or hundreds of factors could be tracked, analyzed, and built into the quoted rate for a particular driver's RFQ. After the analysis, the data may be standardized for the software used by either the insurer or its agents. Finally, the quote may be returned to the customer for acceptance or rejection.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, assembly languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, loading, storing, buffering, and/or transferring data can include the entirety of the data, a portion of the data, a set of the data, and/or a subset of the data. Likewise, reference to reading, writing, loading, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

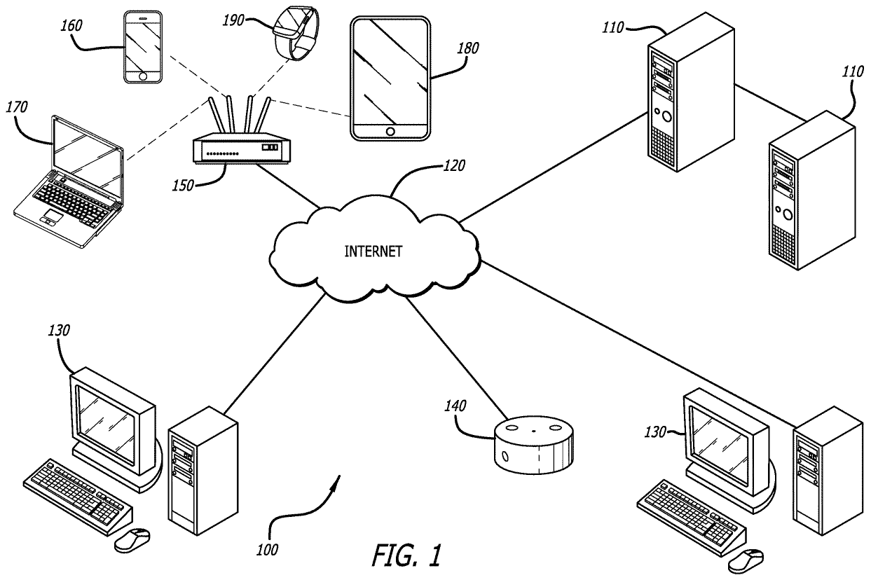

Referring to FIG. 1, a schematic block diagram of a computer network in accordance with an embodiment of the disclosure is shown. Present in computer network 100 may be the Internet 120. Coupled to the Internet 120 may be one or more servers 110, one or more client computers 130, at least one database 140, and at least one local network gateway 150. The local gateway 150 may be coupled to a cellphone 160, a laptop computer 170, a tablet computer 180, and a smartwatch 190. As will be appreciated, the Internet 120 is vast with billions of computers and other electronic devices coupled to it. Computer network 100 may be exemplary of some typical configurations, though by capturing a subset of devices and computers coupled to the Internet 120 virtually any network topology suitable for the present disclosure could be created.

Servers 110 can be of many varieties, from a standalone unit to a plurality of racks in a data center. They can be used to transmit data from one part of the Internet 120 to another, host websites, and store data for retrieval. In some embodiments, Database 140 may be implemented with a type of server called a disk array that typically comprises racks primarily populated by hard disk drives (HDD) and solid state drives (SSD). In some embodiments, servers 110 may serve client computers which may be devices like client computers 130 or any of the devices coupled to the Internet 120 by gateway 150 which may be typically operated by a human being. This degree of interconnectedness allows users to obtain data from virtually anywhere that may be used for business, work, games, entertainment, shopping, etc.

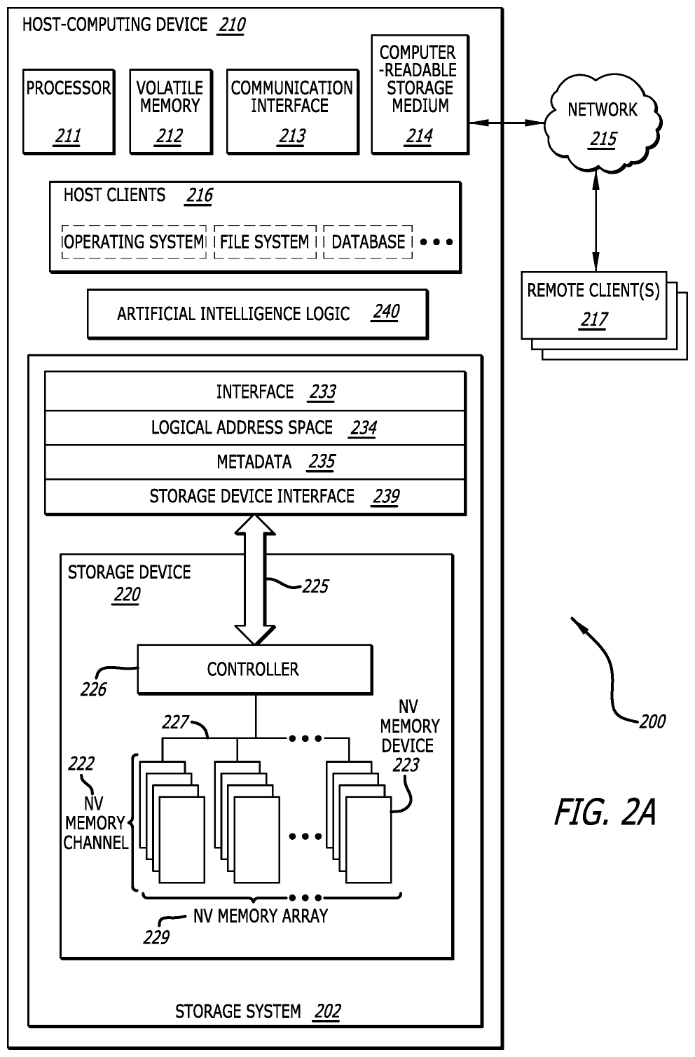

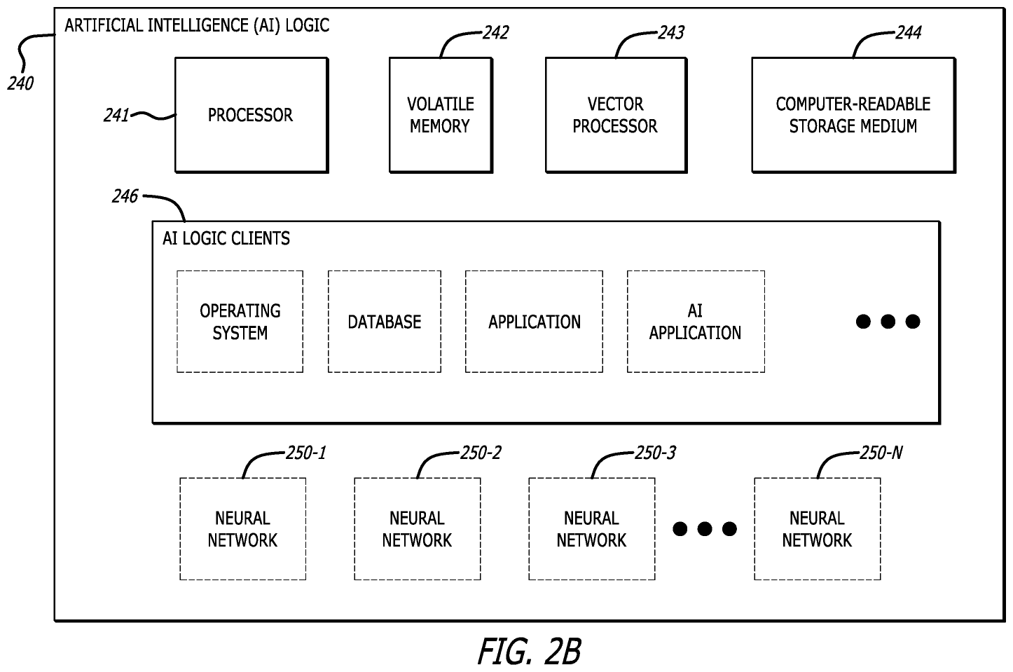

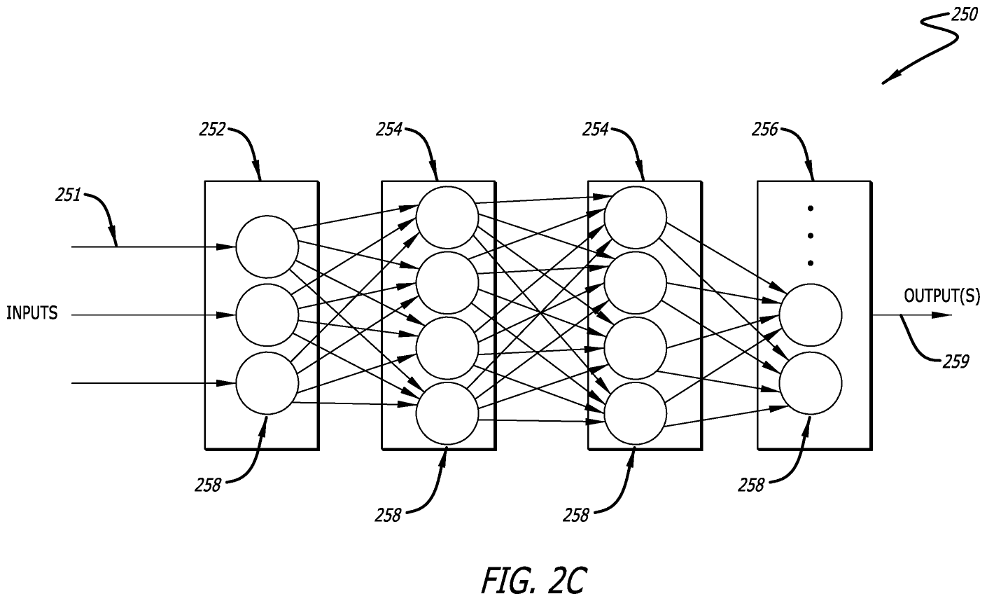

Referring to FIG. 2A, a schematic block diagram of a system comprising a host-computing device in accordance with an embodiment of the disclosure is shown. The system 200 may comprise one or more storage devices 220 of a storage system 202 within a host-computing device 210 in communication via a controller 226. The host-computing device 210 may include a processor 211, volatile memory 212, and a communication interface 213. The processor 211 may include one or more central processing units, one or more general-purpose processors, one or more application-specific processors, one or more virtual processors (e.g., the host-computing device 210 may be a virtual machine operating within a host), one or more processor cores, or the like. The communication interface 213 may include one or more network interfaces configured to communicatively couple the host-computing device 210 and/or controller 226 of the storage device 220 to a communication network such as an Internet Protocol (IP) network, a Storage Area Network (SAN), wireless network, wired network, or the like.

The storage device 220, in various embodiments, may be disposed in one or more different locations relative to the host-computing device 210. In one embodiment, the storage device 220 may comprise one or more non-volatile memory devices 223, such as semiconductor chips or packages or other integrated circuit devices disposed on one or more printed circuit boards, storage housings, and/or other mechanical and/or electrical support structures. For example, the storage device 220 may comprise one or more dual inline memory module (DIMM) cards, one or more expansion cards and/or daughter cards, a solid-state-drive (SSD) or other hard drive device, and/or may have another memory and/or storage form factor. The storage device 220 may be integrated with and/or mounted on a motherboard of the host-computing device 210, installed in a port and/or slot of the host-computing device 210, installed on a different host-computing device 210 and/or a dedicated storage remote client 217 on the network 215, in communication with the host-computing device 210 over an external bus (e.g., an external hard drive), or the like.

The storage device 220, in some embodiments, may be disposed on a memory bus of a processor 211 (e.g., on the same memory bus as the volatile memory 212, on a different memory bus from the volatile memory 212, in place of the volatile memory 212, or the like). In a further embodiment, the storage device 220 may be disposed on a peripheral bus of the host-computing device 210, such as a peripheral component interconnect express (PCI Express or PCIe) bus such, as but not limited to a NVM Express (NVMe) interface, a Serial Advanced Technology Attachment (SATA) bus, a Parallel Advanced Technology Attachment (PATA) bus, a Small Computer System Interface (SCSI) bus, a Serial Attached SCSI (SAS) bus, a FireWire bus, a Fibre Channel connection, a Universal Serial Bus (USB), a PCIe Advanced Switching (PCIe-AS) bus, or the like. In another embodiment, the storage device 220 may be disposed on a communication network 215, such as an Ethernet network, an Infiniband network, SCSI RDMA over a network 215, a storage area network (SAN), a local area network (LAN), a wide area network (WAN) such as the Internet, another wired and/or wireless network 215, or the like.

The host-computing device 210 may further comprise computer-readable storage medium 214. The computer-readable storage medium 214 may comprise executable instructions configured to cause the host-computing device 210 (e.g., processor 211) to perform steps of one or more of the methods disclosed herein.

A device driver and/or the controller 226, in certain embodiments, may present a logical address space 234 to the host clients 216. As used herein, a logical address space 234 refers to a logical representation of memory resources. The logical address space 234 may comprise a plurality (e.g., range) of logical addresses. As used herein, a logical address refers to any identifier for referencing a memory resource (e.g., data), including, but not limited to a logical block address (LBA), a cylinder/head/sector (CHS) address, a file name, an object identifier, an inode, a Universally Unique Identifier (UUID), a Globally Unique Identifier (GUID), a hash code, a signature, an index entry, a range, an extent, or the like.

A device driver for the storage device 220 may maintain metadata 235, such as a logical to physical address mapping structure, to map logical addresses of the logical address space 234 to media storage locations on the storage device(s) 220. The device driver may be configured to provide storage services to one or more host clients 216. The host clients 216 may include local clients operating on the host-computing device 210 and/or remote clients 217 accessible via the network 215 and/or communication interface 213. The host clients 216 may include, but are not limited to: operating systems, file systems, database applications, server applications, kernel-level processes, user-level processes, applications, and the like.

In many embodiments, the host-computing device 210 can include a plurality of virtual machines which may be instantiated or otherwise created based on user-request. As will be understood by those skilled in the art, a host-computing device 210 may create a plurality of virtual machines configured as virtual hosts which is limited only on the available computing resources and/or demand. A hypervisor can be available to create, run, and otherwise manage the plurality of virtual machines. Each virtual machine may include a plurality of virtual host clients similar to host clients 216 that may utilize the storage system 202 to store and access data.

The device driver may be further communicatively coupled to one or more storage systems 202 which may include different types and configurations of storage devices 220 including, but not limited to: solid-state storage devices, semiconductor storage devices, SAN storage resources, or the like. The one or more storage devices 220 may comprise one or more respective controllers 226 and non-volatile memory channels 222. The device driver may provide access to the one or more storage devices 220 via any compatible protocols or interface 233 such as, but not limited to, SATA and PCIe. The metadata 235 may be used to manage and/or track data operations performed through the protocols or interfaces 233. The logical address space 234 may comprise a plurality of logical addresses, each corresponding to respective media locations of the one or more storage devices 220. The device driver may maintain metadata 235 comprising any-to-any mappings between logical addresses and media locations.

A device driver may further comprise and/or be in communication with a storage device interface 239 configured to transfer data, commands, and/or queries to the one or more storage devices 220 over a bus 225, which may include, but is not limited to: a memory bus of a processor 211, a peripheral component interconnect express (PCI Express or PCIe) bus, a Serial Advanced Technology Attachment (SATA) bus, a Parallel ATA bus, a small computer system interface (SCSI), FireWire, Fibre Channel, a Universal Serial Bus (USB), a PCIe Advanced Switching (PCIe-AS) bus, a network 215, Infiniband, SCSI RDMA, or the like. The storage device interface 239 may communicate with the one or more storage devices 220 using input-output control (IO-CTL) command(s), IO-CTL command extension(s), remote direct memory access, or the like.

The communication interface 213 may comprise one or more network interfaces configured to communicatively couple the host-computing device 210 and/or the controller 226 to a network 215 and/or to one or more remote clients 217 (which can act as another host). The controller 226 is part of and/or in communication with one or more storage devices 220. Although FIG. 2A depicts a single storage device 220, the disclosure is not limited in this regard and could be adapted to incorporate any number of storage devices 220.

The storage device 220 may comprise one or more non-volatile memory devices 223 of non-volatile memory channels 222, which may include but is not limited to: ReRAM, Memristor memory, programmable metallization cell memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), programmable metallization cell (PMC), conductive-bridging RAM (CBRAM), magneto-resistive RAM (MRAM), magnetic storage media (e.g., hard disk, tape), optical storage media, or the like. The one or more non-volatile memory devices 223 of the non-volatile memory channels 222, in certain embodiments, may comprise storage class memory (SCM) (e.g., write in place memory, or the like).

The non-volatile memory channels 222 may more generally comprise one or more non-volatile recording media capable of recording data, which may be referred to as a non-volatile memory medium, a non-volatile memory device, or the like. Further, the storage device 220, in various embodiments, may comprise a non-volatile recording device, a non-volatile memory array 229, a plurality of interconnected storage devices in an array, or the like.

The non-volatile memory channels 222 may comprise one or more non-volatile memory devices 223, which may include, but are not limited to: chips, packages, planes, die, or the like. A controller 226 may be configured to manage data operations on the non-volatile memory channels 222, and may comprise one or more processors, programmable processors (e.g., FPGAs), ASICs, micro-controllers, or the like. In some embodiments, the controller 226 is configured to store data on and/or read data from the non-volatile memory channels 222, to transfer data to/from the storage device 220, and so on.

The controller 226 may be communicatively coupled to the non-volatile memory channels 222 by way of a bus 227. The bus 227 may comprise an I/O bus for communicating data to/from the non-volatile memory devices 223. The bus 227 may further comprise a control bus for communicating addressing and other command and control information to the non-volatile memory devices 223. In some embodiments, the bus 227 may communicatively couple the non-volatile memory devices 223 to the controller 226 in parallel. This parallel access may allow the non-volatile memory devices 223 to be managed as a group, forming a non-volatile memory array 229. The non-volatile memory devices 223 may be partitioned into respective logical memory units (e.g., logical pages) and/or logical memory divisions (e.g., logical blocks). The logical memory units may be formed by logically combining physical memory units of each of the non-volatile memory devices 223.

The controller 226 may organize a block of word lines within a non-volatile memory device 223, in certain embodiments, using addresses of the word lines, such that the word lines are logically organized into a monotonically increasing sequence (e.g., decoding and/or translating addresses for word lines into a monotonically increasing sequence, or the like). In a further embodiment, word lines of a block within a non-volatile memory device 223 may be physically arranged in a monotonically increasing sequence of word line addresses, with consecutively addressed word lines also being physically adjacent (e.g., WL0, WL1, WL2, . . . WLN).

The controller 226 may comprise and/or be in communication with a device driver executing on the host-computing device 210. A device driver may provide storage services to the host clients 216 via one or more interfaces 233. A device driver may further comprise a storage device interface 239 that is configured to transfer data, commands, and/or queries to the controller 226 over a bus 225, as described above.

Host-computing device 210 may further comprise artificial intelligence (AI) logic 240 configured to implement various AI functions like, for example, artificial neural networks, machine learning, expert systems, and the like. In various embodiments, AI logic 240 may be implemented as a hardware function, a software function, or any combination thereof. In some embodiments, AI logic may comprise computer executable code which may execute on processor 211, a remote client 217, one or more dedicated processors, and/or on one or more virtual processors. The machine executable code may be retrieved and executed from computer-readable storage 214, one of the host clients 216, a computer-readable storage medium dedicated to AI logic 240, etc.

Referring to FIG. 2B, a schematic block diagram of an artificial intelligence logic in accordance with an embodiment of the disclosure is shown. Artificial Intelligence (AI) logic 240 may comprise a processor 241, a volatile memory 242, and a vector processor 243. Processor 241 may comprise multiple central processing units and may be used to control the overall functioning of the AL logic 240. Processor 241 may be, for example, a Complex Instruction Set Computer (CISC) architecture or a Reduced Instruction Set Computer (RISC) architecture. Vector processor 243 may provide multiple compute cores and may be a Single Instruction Multiple Data (SIMD) architecture, a Graphics Processing Unit (GPU) architecture, or the like. Some SIMD processors may operate on long data words like, for example, 128 bits or 256 bits or more. In additional to the usual add/multiply/accumulate functions, the highly parallel nature of a SIMD processor may lend itself to adding additional logic in the vector functions tailored to AI and adding additional AI related opcodes to use it. In some embodiments, vector processor 243 may be optional.

AI logic 240 may use artificial neural networks 250-1 through 250-N for the AI logic functions. In other embodiments, the AI logic processing may be done in vector processor 243 and the artificial neural networks 250-1 through 250-N are optional. In still more embodiments, vector processor 243 and the artificial neural networks 250-1 through 250-N may be optional and the AI functions are performed by processor 241. In certain embodiments, the artificial neural networks 250-1 through 250-N may be virtual artificial networks. In various embodiments, processor 241 and/or volatile memory 242 may be optional and their functionality may, for example, be performed by processor 211 and volatile memory 212 in host-computing device 210.

Volatile memory 242 may be used, for example, to provide working memory for processor 241 and/or vector processor 243. The AI logic 240 may further comprise computer-readable storage medium 244. The computer-readable storage medium 244 may comprise executable instructions configured to cause processor 241 and/or vector processor 244 to perform one or more of the methods disclosed herein. Volatile memory 242 may also be used for other functions like, for example, to store the executable instructions of computer-readable storage medium 244 for faster execution, or to host various AI logic clients 246 used in the operation of the AI logic 240.

Examples of AI logic clients 246 may include, but are not limited to: operating systems, file systems, database applications, server applications, kernel-level processes, user-level processes, applications, AI applications and the like. An operating system may execute on processor 241. In some embodiments, vector processor 243 may run its own operating system, while in other embodiments it may be synchronized with processor 241 and execute SIMD or AI opcodes or the like, as they occur in the instructions executed by processor 241. AI logic functionality typically requires substantial data to operate on, and such data may be stored in one or more database clients. A variety of applications may be present, and in many embodiments, there may be AI applications executing on processor 241 and/or vector processor 243. One or more of these AI applications may be used to control the AI analysis functionality, while others may do other tasks in service thereof.

One or more artificial neural networks 250-1, 250-2, 250-3, and 250-N may be present in AI logic 240. In some embodiments, artificial neural networks 250-1, 250-2, 250-3, and 250-N may be implemented in dedicated hardware, while in various embodiments, their function may be performed by an AI application executing on processor 241 and/or vector processor 243 and/or processor 210 and/or a remote client 217. In other embodiments, a combination of hardware artificial neural networks 250-1, 250-2, 250-3, and 250-N may be used in parallel with AI applications running on processor 241 and/or vector processor 243 and/or processor 210 and/or a remote client 217.

Referring to FIG. 2C, a conceptual illustration of an artificial neural network in accordance with an embodiment of the disclosure is shown. The artificial neural network 250 may comprise an input layer 252, one or more intermediate layers 254, and an output layer 256. The artificial neural network 250 may comprise a collection of connected units or nodes 258 called artificial neurons which loosely model the neurons in a biological brain. A few exemplary nodes 258 have been labeled in the figure. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 250 depicted in FIG. 2C is shown as an illustrative example and various embodiments may comprise artificial neural networks that can accept more than one type of input and can provide more than one type of output. Further, there may be multiple types of artificial neurons 258.

In a typical embodiment, the signal at a connection between artificial neurons is an integer, and the output of each artificial neuron is computed by some non-linear function (called an activation function) of the sum of the artificial neuron's inputs. The connections between artificial neurons are called “edges” or axons. Artificial neurons and edges typically have a weight that adjusts as learning proceeds. The weight increases or decreases the strength of the signal at a connection. Artificial neurons may have a threshold (or trigger threshold) such that the signal is only sent if the aggregate signal crosses that threshold. Typically, artificial neurons maybe aggregated into layers. Different layers may perform different kinds of transformations on their inputs. Signals propagate from the first layer (the input layer 252) to the last layer (the output layer 256), possibly after traversing one or more intermediate layers 254 (also called hidden layers).

The inputs to an artificial neural network may vary depending on the problem being addressed. For example, in object detection in a video stream, the inputs may be data representing pixel values for certain pixels within an image or frame. In one embodiment the artificial neural network 250 comprises a series of hidden layers in which each neuron is fully connected to neurons of the next layer. The artificial neural network 250 may utilize an activation function such as sigmoid, nonlinear, or a rectified linear unit (ReLU), upon the sum of the weighted inputs for example. The last layer in the artificial neural network may implement a regression function such as SoftMax regression to produce the classified or predicted classifications output for object detection as output 259. In further embodiments, a sigmoid function can be used, and position prediction may need raw output transformation into linear and/or non-linear coordinates.

In certain embodiments, the artificial neural network 250 is trained prior to deployment and to conserve operational resources. However, other embodiments may utilize ongoing training of the artificial neural network 250 especially when operational resource constraints such as die area and performance are less critical.

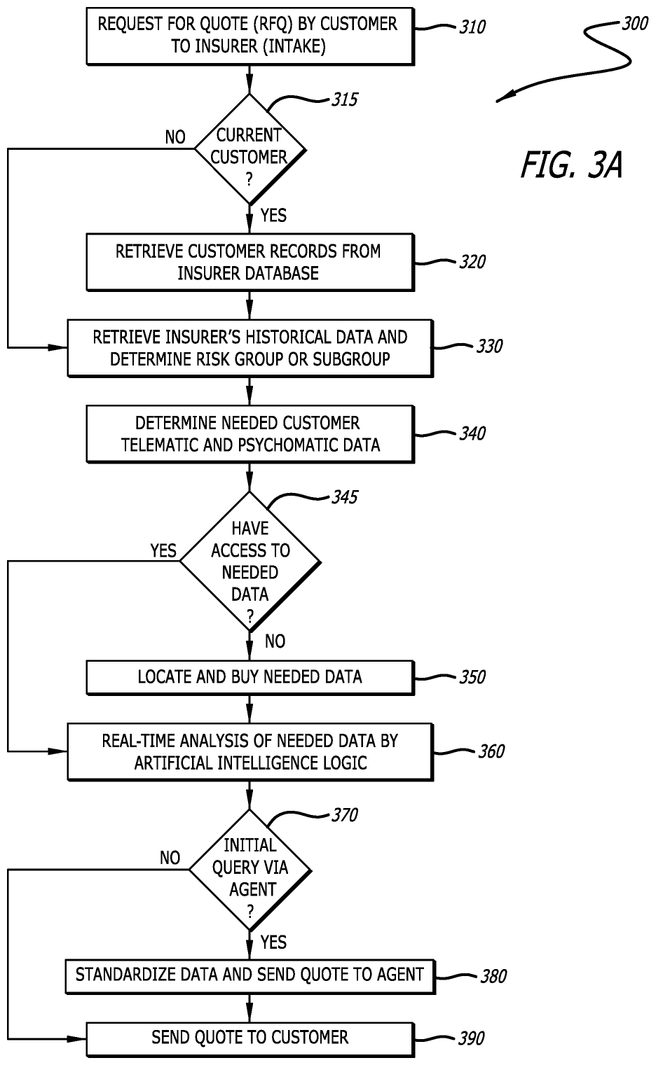

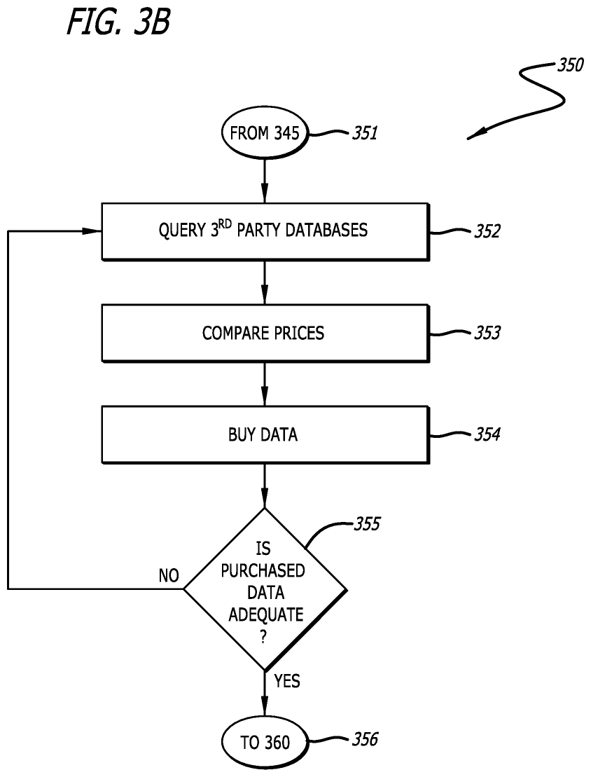

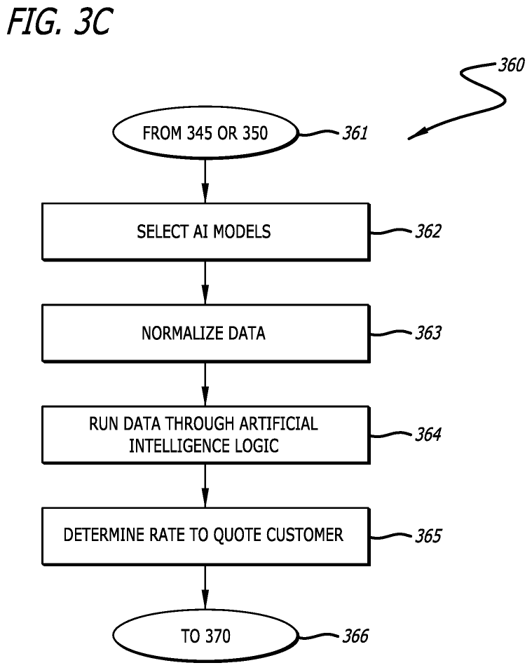

Referring to FIG. 3A, a flowchart depicting a process 300 for risk determination in accordance with an embodiment of the disclosure is shown. While the exemplary embodiment of process 300 may illustrate the invention with respect to obtaining auto insurance rate quotes, the inventive concepts herein may have applications in other fields. Process 300 may begin with an insurer receiving a Request For Quote (RFQ) from a customer or potential customer (block 310). The RFQ may come in via an agent, a website, a mobile application, an airport kiosk, etc. The customer data in the RFQ may then be presented to the insurer's customer intake system for analysis.

The process 300 may determine if the customer is new or is an existing customer (block 315). If it is an existing customer, that customer's data, including state vehicle driver and/or vehicle records, can be retrieved for inclusion in the analysis (block 320). In either case, the insurer's historical database can be retrieved for inclusion in the analysis (block 330). This may allow the insurer to determine the risk group and/or risk subgroup (e.g., a more accurate determination for a new or an existing customer) using legacy methods. This historical data may be securely transmitted to other parties like, for example, other insurers or general managing agents.

Process 300 may determine what additional data is needed to personalize the quoted rate for the customer (block 340). Telematic data is one class of information that may be used to determine risk more accurately. Telematic data may be derived from the customer's vehicle itself. Modern cars typically have several dozen microcontrollers performing different functions. These microcontrollers are typically coupled together with some version of the Controller Area Network (CAN) bus, which is a robust two-wire differential serial bus that is broadcast capable. The CAN bus microcontrollers may be accessed through a diagnostic port in the vehicle which may access all available data in the car's internal network. The sort of data that may be obtained can provide insights into a driver's habits and thus affect the insurance rate quoted.

For example, a device with cellular communications capabilities may be coupled to a car's diagnostic port and may monitor a customer's driving skill by reporting data on acceleration, breaking, cornering, and/or the activation of driver-assist features in real time. Other data that may be procured may be the type of vehicle driven, like automatic or manual transmission, and/or gasoline, electric or hybrid vehicle, and/or degree of self-driving, and the like. Indeed, auto manufacturers may build this feature into their vehicles to gather data for such purposes as safety monitoring and/or procuring customer data for marketing purposes and/or selling the marketing data to other companies. Other data that may be procured this way is a customer's destinations, routes, distances traveled, stops, maintenance habits, and/or time of day for all of the above. In some embodiments, this telematic data may be used to set an individual customer's rates, while in other embodiments, this data may be used to provide real-time data on fleets of vehicles operated by companies. This telematic data may be securely transmitted to other parties like, for example, other insurers or general managing agents.

Psychographic data is another class of information that may be used to determine risk more accurately. Psychographic data may be derived from sources other than the customer's vehicle, and in particular, from the customer's Internet footprint. In some embodiments the data obtained may be information about the customer's social media, lifestyle, use of mobile apps, subscriptions to magazines, websites, news, blogs, etc., the customer's credit reports, and/or retail purchases (time, place, transaction details, etc.). For example, if a customer stops at a particular fast-food restaurant near home on the way to work most days and typically orders hot food, it may provide insight into whether the driver is eating breakfast on the way to work and thus paying less attention to the road. This psychographic data may be securely transmitted to other parties like, for example, other insurers or general managing agents.

The process 300 may determine if it has access to the needed data (block 345). If the data is not currently available the process 300 may search online to locate, and/or purchase the needed data (block 350). The details of this subprocess will be further described in conjunction with FIG. 3B. In either case, the process 300 may perform a real-time analysis using artificial intelligence logic to determine the rate to return for the RFQ (block 360). The details of this subprocess will be further described in conjunction with FIG. 3C.

The process 300 may determine if the RFQ originated with an agent (block 370). If so, the data is standardized to be compatible with the software the agent uses and then the RFQ response data is sent to the agent (block 380). In either case, the rate quotation is the sent to the customer for approval (block 390).

Referring to FIG. 3B, a flowchart depicting a subprocess 350 for data acquisition in accordance with an embodiment of the disclosure is shown. Subprocess 350 may begin when it has been determined that additional data is needed to process the RFQ (block 351). The subprocess 300 may then query third-party databases for the needed data (block 352). If some or all of the data is available from multiple sources the subprocess may compare the prices from these sources (block 353) and may purchase the data (block 354). The subprocess 350 may determine if the purchased data is adequate for the needed analysis (block 355). If it is not, further searching may be performed (block 352), otherwise the subprocess 350 may return to the process 300 (block 356).

Referring to FIG. 3C a flowchart depicting a subprocess 360 for data analysis in accordance with an embodiment of the disclosure is shown. Subprocess 360 may begin when it has been determined that no additional data is needed to process the RFQ (block 361). Based upon the available data, the subprocess 360 may select which AI models are to be used (block 362) and then normalize the available data into the most suitable format for the selected models (block 363). The data is then presented to the artificial intelligence logic (block 364) which then determines the rate in response to the RFQ (block 365). The subprocess 360 then returns to the process 300 (block 366).

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a first processor;
a first memory;
a communication interface configured to be coupled to a network; and
an artificial intelligence logic, configured to:
receive a request to generate a quote from a customer,
access historical data about the customer,
retrieve third-party data about the customer,
analyze the historical and third-party data to determine the quote, and return the quote to the customer.

2. The device of claim 1, wherein the artificial intelligence logic further comprises:
a second processor;
a second memory; and
a computer-readable storage medium, wherein the computer-readable storage medium comprises machine executable code configured to implement a first artificial intelligence function, wherein the first artificial intelligence function executes on the second processor.

3. The device of claim 2, wherein the second processor is a virtual processor.

4. The device of claim 2, wherein:
the artificial intelligence logic further comprises a first artificial neural network; and
the first artificial intelligence function controls the first artificial neural network.

5. The device of claim 4, wherein the first artificial neural network implements a machine learning model.

6. The device of claim 4, wherein the first artificial neural network is a virtual artificial neural network.

7. The device of claim 6, wherein the first artificial neural network implements a machine learning model.

8. The device of claim 2, wherein:
the artificial intelligence logic further comprises a vector processor;
the computer-readable storage medium further comprises machine executable code configured to implement a second artificial intelligence function; and
the second artificial intelligence function executes on the vector processor.

9. The device of claim 8, wherein the vector processor is a graphics processing unit.

10. The device of claim 8, wherein the vector processor has a single instruction multiple data (SIMD) architecture.

11. The device of claim 8, wherein:
the quote is for a vehicle insurance rate; and
the third-party data consists of at least one of the group consisting of: telematic data and psychographic data.

12. The device of claim 4, wherein:
the quote is for a vehicle insurance rate; and
the third-party data consists of at least one of the group consisting of: telematic data and psychographic data.

13. The device of claim 2, wherein:
the quote is for a vehicle insurance rate; and
the third-party data consists of at least one of the group consisting of: telematic data and psychographic data.

14. The device of claim 1, wherein:
the quote is for a vehicle insurance rate; and
the third-party data consists of at least one of the group consisting of: telematic data and psychographic data.

15. The device of claim 1, wherein the third-party data is purchased in real time.

16. The device of claim 1, wherein the third-party data is purchased prior to the request from the customer.

17. The device of claim 1, wherein the historic data is obtained in real time.

18. The device of claim 1, wherein the historic data is obtained prior to the request from the customer.

19. The device of claim 1, wherein the device is one of the group consisting of: a mobile device, a server, a client, a computer, a tablet computer, a cellphone, and a kiosk.

20. The device of claim 1, wherein the artificial intelligence logic is further configured to convert to a standard data format at least one of the group consisting of: the historical data, the third-party data, the analysis results, and the quote.
